(19) United States
(12) Patent Application Publication
(10) Pub. No.: US 2026/0145477 A1
(43) Pub. Date: May 28, 2026

(54) RIDE CONTROL TUNING FOR MODE DIFFERENTIATION IN ACTIVE SUSPENSION SYSTEMS

(71) Applicant: ClearMotion, Inc., Billerica, MA (US)

(72) Inventors: Timothy Vernon Light, Tamworth (GB); Robert Fern, Warwickshire (GB)

(21) Appl. No.: 19/110,286

(22) PCT Filed: Sep. 11, 2023
(86) PCT No.: PCT/US2023/073900

§ 371 Date: Mar. 10, 2025

Related U.S. Application Data
(60) Provisional application No. 63/405,645, filed on Sep. 12, 2022.
(60) Provisional application No. 63/491,371, filed on Mar. 21, 2023.

(51) Int. Cl. B60G 17/0165; B60G 17/018; B60G 17/019

(52) U.S. Cl. CPC B60G 17/0165; B60G 17/018; B60G 17/01908; B60G 2400/202; B60G 2400/204; B60G 2500/10; B60G 2600/17; B60G 2600/20; B60G 2600/602; B60G 2600/604; B60G 2800/014

(57) ABSTRACT

A vehicle may include a chassis and/or vehicle body, a plurality of wheels or wheel assemblies, an active suspension system operatively coupled to the plurality of wheels or wheel assemblies and the chassis and/or vehicle body, and at least one processor configured to control the active suspension system. The at least one processor may be configured to obtain a tuning parameter, determine a first vehicle parameter, determine a second vehicle parameter, determine a blended vehicle parameter based at least partly on the tuning parameter, the first vehicle parameter, and the second vehicle parameter, and command the at least one actuator to apply force between at least one of the plurality of wheels or wheel assemblies and the chassis and/or vehicle body based at least partly on the blended vehicle parameter.

### RELATED APPLICATIONS

This application claims the benefit of priority under 35 U.S.C. § 119(e) of U.S. application Ser. No. 63/491,371, filed Mar. 21, 2023 and U.S. application Ser. No. 63/405,645, filed Sep. 12, 2022, the disclosures of which are incorporated herein by reference in their entirety.

### FIELD

Disclosed embodiments are related to ride control tuning systems for mode differentiation in active suspension systems, as well as related methods.

### BACKGROUND

Suspension systems are typically designed to properly support and orient a vehicle, provide safe handling in various expected operating environments and ensure a comfortable ride for occupants. Conventional suspension systems are typically passive with largely constant operating and performance parameters. Some suspension systems are semi-active in that their overall damping response can be adjusted, for example, to offer a trade-off between occupant comfort and vehicle handling. Fully active suspension systems use actuators to react to changing road conditions using input from sensors and other measurement devices to provide appropriate damping and/or active forces in response to the sensed road conditions.

### SUMMARY

In some aspects, the techniques described herein relate to a vehicle including: a chassis and/or vehicle body; a plurality of wheels or wheel assemblies; an active suspension system operatively coupled to the plurality of wheels or wheel assemblies and the chassis and/or vehicle body, where the active suspension system includes at least one actuator configured to apply active forces to at least one of the plurality of wheels or wheel assemblies in at least one mode of operation; and at least one processor configured to control the active suspension system, where the at least one processor is configured to: obtain a tuning parameter, determine a first vehicle parameter, determine a second vehicle parameter, determine a blended vehicle parameter based at least partly on the tuning parameter, the first vehicle parameter, and the second vehicle parameter, and command the at least one actuator to apply force between at least one of the plurality of wheels or wheel assemblies and the chassis and/or vehicle body based at least partly on the blended vehicle parameter.

In some aspects, the techniques described herein relate to a method of controlling a vehicle including a chassis and/or vehicle body, a plurality of wheels or wheel assemblies, and an active suspension system, where the active suspension system is operatively coupled to the plurality of wheels or wheel assemblies, and where the active suspension system includes at least one actuator configured to apply active forces to at least one of the plurality of wheels or wheel assemblies in at least one mode of operation, the method including: obtaining a tuning parameter; determining a first vehicle parameter; determining a second vehicle parameter; determining a blended vehicle parameter based at least partly on the tuning parameter, the first vehicle parameter, and the second vehicle parameter; and commanding the at least one actuator to apply force between at least one of the plurality of wheels or wheel assemblies and the chassis and/or vehicle body based at least partly on the blended vehicle parameter.

In some embodiments, a non-transitory computer readable medium may include processor executable instructions that when executed by at least one processor perform the above method.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of one embodiment of a vehicle including an active suspension system;

FIG. 2 is a schematic of an embodiment of a vehicle under chassis and/or vehicle body isolation control;

FIG. 3 is a schematic of an embodiment of a vehicle under road tracking control;

FIG. 4 is a schematic of an embodiment of a vehicle under a blended chassis and/or vehicle body isolation and road isolation control;

FIG. 5 is a block diagram of one embodiment of a vehicle control system;

FIG. 6 depicts one embodiment of a tuning strategy for a vehicle control system including different modes;

FIG. 7 is a flow chart of one embodiment of a method of controlling a vehicle; and

FIG. 8 is a flow chart of another embodiment of a method of controlling a vehicle.

### DETAILED DESCRIPTION

A vehicle is a complex dynamic system with a multitude of different tuning parameters that may affect the performance of the vehicle when exposed to different road conditions. For example, spring and damping characteristics of a suspension system may affect how the vehicle responds to external forces (e.g., encountering a road feature such as a pothole or bump) and/or user input (e.g., throttle input, brake input, steering input). Additional parameters such as wheel or wheel assembly travel, sprung weight, unsprung weight, weight distribution, and others that may affect how a vehicle chassis and/or vehicle body may move in response to certain conditions. The vehicle responses that result from the interactions of these various parameters are perceptible to a driver or other occupants of the vehicle, and may affect the driver's and/or occupant's subjective perception of the driving experience.

As a vehicle includes multiple systems which may affect one another, tuning various parameters of a vehicle control system, and in particular suspension systems, is a complex process that is difficult and time consuming. For example, tuning a particular parameter to make what is perceived as a positive change for one aspect of vehicle performance may result in a negative change for another aspect of the vehicle performance. For instance, softening dampening rates in a suspension system may improve comfort, but may also make the vehicle feel unresponsive to steering inputs. Where active or semi-active control of various vehicle systems is employed (e.g., an active suspension system), the tuning problem may become even more complex, as the application of active forces can generate instabilities or otherwise result in undesirable vehicle performance. Tuning of gain factors in vehicle system control modules, including active or semi-active suspension system control modules, is complex and time consuming. In many vehicles, different driving modes (e.g., sport, comfort, economical) may be employed which change various control parameters of the vehicle, meaning the tuning process must be completed for each additional mode, further increasing complexity and time needed to perform such a process. As many different vehicle systems operate together and affect one another, typically multiple different control schemes are used for different vehicle modes. That is, a completely different control module employing different gain factors and/or inputs may be employed to control different subsystems of a vehicle in different modes in conventional systems. For example, a vehicle including an active suspension system operating in a comfort mode may employ a chassis and/or vehicle body isolation control module, whereas a vehicle in a sport mode may employ a separate road tracking control module. Use of different control modules requires the separate, independent tuning of each control module, increasing the amount of time and complexity to provide a vehicle control system for the different operating modes.

In view of the above, the inventors have recognized the benefits of a vehicle control system employing a consistent control topology for different vehicle operating modes and employing one or more tuning parameters that may be used to effectively adapt the general control topology to different vehicle modes. That is, the inventors have recognized the benefits of a methodology for ride control tuning in an active suspension system of a vehicle, such that different dynamic characteristics may be displayed by the vehicle without implementing an entirely different control module. By adjusting the one or more tuning parameters, it may be possible to support vehicle modes such as comfort (e.g., maximizing passenger comfort), sport (e.g., maximizing road tracking) and economical (e.g., reducing energy consumption) vehicle operating modes using a single control topology. In some embodiments, the methodology may include tuning a frequency blend of chassis and/or vehicle body isolation control (e.g., skyhook) and road tracking control (e.g., groundhook). The inventors have recognized the particular benefits of a crossover frequency setting for blending chassis and/or vehicle body control and road tracking control for effecting different vehicle modes, as discussed further herein. The control strategies disclosed relative to the various exemplary embodiments described herein may be generalized and applicable to controlling a variety of vehicle chassis and/or vehicle body motions, including, but not limited to, vehicle heave, pitch and/or roll motions.

The inventors have also recognized the benefits of a vehicle control system having different modes for operating different vehicle subsystems differently. For example, in some cases a user of a vehicle may desire a sport mode, where a vehicle control system may increase throttle response, increase steering weight, control an active suspension to improve road tracking and reduce chassis and/or vehicle body pitch and roll while increasing force feedback provided to the user through the chassis and/or vehicle body (e.g., by increasing passive or active damping of the suspension), and/or provide other appropriate vehicle performance modifications. In some embodiments, in a sport mode an active suspension may alter active forces applied to the wheels or wheel assemblies of the vehicle to provide the sensation of a stiffer, more sporty suspension. In some cases, the inventors have recognized that a vehicle control system implementing more road tracking control may feel sportier than a vehicle control system implementing more chassis and/or vehicle body isolation control. As another example, in some cases a user of a vehicle may desire a comfort mode, where a vehicle control system may decrease throttle response, lighten steering weight, control an active suspension to improve chassis and/or vehicle body isolation from external disturbances (e.g., by reducing passive or active damping of the suspension), and/or provide other appropriate vehicle performance modifications. In some embodiments, in a comfort mode an active suspension may alter active forces applied to the wheels or wheel assemblies of the vehicle to provide the sensation of floating above a road surface where force transmission from the wheels or wheel assemblies to the vehicle chassis and/or vehicle body associated with road inputs may be at least partially mitigated such that there may be little to no force transmission to the chassis and/or vehicle body of the vehicle from disturbances associated with these road inputs. In some cases, the inventors have recognized that a vehicle control system implementing more chassis and/or vehicle body isolation control may feel more comfortable than a vehicle control system implementing more road tracking control. As yet another example, in some cases a user of a vehicle may desire to conserve energy in an economical mode, where a vehicle control system may limit the throttle, improve coasting, adjust a climate control system, control an active suspension to reduce energy use (e.g., by limiting application of active forces), and/or provide other appropriate vehicle performance modifications. In some embodiments, in an economical mode an active suspension may apply fewer active forces to the wheels or wheel assemblies of the vehicle which may reduce energy consumption of the active suspension.

In some embodiments, a vehicle control system for a vehicle including an active suspension system may be configured to receive one or more tuning parameters to achieve a desired vehicle operational mode. In some embodiments, a vehicle operation mode may include comfort, sport, and economical. In other embodiments, other vehicle modes may be implemented, as the present disclosure is not so limited. In some embodiments, a comfort mode may be configured to deliver increased passenger isolation from road disturbances. In some embodiments, a sport mode may be configured to deliver increased road tracking. In some embodiments, an economical mode may represent, for example, an intermediate mode between the sport mode and the comfort mode, for example, providing a moderate amount of isolation without excessive energy consumption (e.g., caused by force application at the active suspension system).

In some embodiments, a vehicle may include a chassis and/or vehicle body, a plurality of wheels or wheel assemblies (e.g., unsprung masses), an active suspension system operatively coupled to the plurality of wheels or wheel assemblies and the chassis and/or vehicle body. The active suspension system may include at least one actuator configured to be interposed between at least one of the plurality of wheels or wheel assemblies and the chassis and/or vehicle body. The vehicle may also include a vehicle control system including at least one processor configured to control the active suspension system. The at least one processor may be an active suspension system control module or a portion of an active suspension system control module. The at least one processor may be configured to obtain a tuning parameter. In some embodiments, the tuning parameter may be, for example, a single parameter that may be used to adjust the overall control of the suspension system based on a particular value of the tuning parameter. For example, as discussed further below, in some embodiments the tuning parameter may be a frequency used in the determination of forces to be applied between the plurality of wheels or wheel assemblies and the chassis and/or vehicle body. For example, the tuning parameter frequency may be employed to determine a filter applied to inputs to a vehicle control system. In other embodiments, the tuning parameter may be a weighting factor, and may have any units or be unitless. The tuning factor may be based on the selection of a vehicle mode by a user and may be obtained as user input. The at least one processor may also be configured determine two different vehicle parameters. In some embodiments, a vehicle parameter may be an input to a control module and may be measurable or otherwise determinable based on feedback or sensor information. In some embodiments, a first vehicle parameter may be a parameter of the vehicle chassis and/or vehicle body (e.g., chassis and/or vehicle body velocity, chassis and/or vehicle body acceleration, etc.). In some embodiments, a second vehicle parameter may be a parameter of the vehicle suspension (e.g., suspension velocity, suspension acceleration, etc.). Based on the two vehicle parameters and the tuning parameter, the at least one processor may blend the two vehicle parameters to create a blended vehicle parameter. The at least one processor may then use the blended vehicle parameter to determine a force to be applied by the active suspension system between the wheels or wheel assemblies and the chassis and/or vehicle body. By implementing this arrangement, the tuning parameter may enable faster and more straightforward vehicle mode tuning, as adjustment of the tuning parameter may change the dynamics of the vehicle by altering the blended vehicle parameter used as an input for force determination. Specific examples of tuning parameters and determination of a blended vehicle parameter based on a tuning parameter are described further below.

In some embodiments, a vehicle control system may employ a complementary filter to create a frequency blended input of a first vehicle parameter input and second vehicle parameter input. In some embodiments, the first vehicle parameter input may be suspension velocity (e.g., velocity of the extension and/or retraction of the suspension system), and the second vehicle parameter input may be chassis and/or vehicle body velocity (e.g., inertial velocity). As used herein, an “inertial velocity” or a “chassis and/or vehicle body velocity” may refer to a velocity of the chassis and/or vehicle body in the vertical direction relative to an underlying supporting surface. As used herein, a “suspension velocity” may refer to a velocity of a component of a suspension system (e.g., a suspension system actuator) or a unsprung mass (e.g., wheel or wheel assembly) in a vertical direction relative to an underlying supporting surface. The complementary filter may be based on the one or more tuning parameters. For example, the one or more tuning parameters may include a crossover frequency, where the suspension velocity is the dominant input in the content below the crossover frequency, and the inertial velocity is the dominant input in the content above the crossover frequency. For example, the complementary filter includes applying a low pass filter to one input and a high pass filter to the other input at the crossover frequency. In this example, the resulting filtered inputs may then be added together to create the blended input. This frequency blend may provide a continuum of vehicle mode possibilities. When the crossover frequency is decreased towards zero, the blended velocity becomes closer to a pure inertial velocity, making the signal suitable for chassis and/or vehicle body isolation dominant control (which may be employed for a comfort mode). Conversely if the frequency is raised further above zero, the signal contains greater suspension velocity content, making the signal suitable for road tracking dominant control (which may be employed for sport mode). A simple adjustment of this crossover frequency may assist in changing the primary ride characteristics of the vehicle, such that the vehicle can adopt different vehicle modes of operation for an active suspension system simply based on the different crossover frequencies associated with these different vehicle modes. Accordingly, a comfort mode may be associated with a first crossover frequency, a sport mode may be associated with a second crossover frequency greater than the first crossover frequency, and an economical mode may be associated with a third crossover frequency between the first crossover frequency and the second crossover frequency. The vehicle control system may be configured to receive user input related to a desired vehicle mode (e.g., via a user interface such as a touch screen, button, switch, etc.). Based on the user input, the vehicle control system may modify the crossover frequency of the complementary filter. While addition of signals may be employed in exemplary embodiments herein, in other embodiments other types of combinations of the signals may be employed to form a blended input, as the present disclosure is not so limited.

In some embodiments, a vehicle control system may employ a different damping gain for different vehicle modes that may be determined based at least in part on a particular vehicle mode to be implemented. The damping gain may be applied after a blended input parameter is determined based on one or more tuning parameters (e.g., crossover frequency). The level of the damping gain may allow for a continuum of damping levels based on the blended input parameter. A smaller damping gain (e.g., closer to zero) may be employed for an underdamped response in an economical mode. A larger damping gain (e.g., further from zero) may be employed for an overdamped response in a comfort mode. A medium damping gain (e.g., between the smaller and larger damping gains), may be employed for a critically damped response in a sport mode.

In some embodiments, through the combination of control parameters described above, such as a crossover frequency and a damping gain, a single control topology may be employed by a vehicle control system, greatly simplifying vehicle tuning by limiting the number of tuning parameters. That is, this disclosure describes a single control topology that can deliver a spectrum of vehicle modes, without needing more complex software implementing a plurality of different control modules for a vehicle suspension system. The number of parameters is relatively small, yielding a more easily tunable system.

Although in some embodiments the one or more tuning parameters (e.g., crossover frequency and damping gain) may be the dominant parameters, certain modes may be enhanced by additional linear filters. Thus, in some embodiments, a vehicle control system may employ one or more filters. More specifically, in some embodiments, a low pass filter may be used in a sport mode to raise the apparent natural frequency of the system. In some embodiments, a phase lead filter may be used in a comfort mode to increase isolation at secondary ride frequencies (e.g., high frequencies).

In some embodiments, a tuning parameter for a vehicle control system may be received as user input. For example, a vehicle may include an infotainment system or other user interfaces that allow a user to input information. In some embodiments, a vehicle may include a button, switch, dial, touch screen, keyboard, voice recognition system, or other input device that a user may use to provide user input. In some embodiments, a tuning parameter may be associated with a particular vehicle mode. For example, a tuning parameter may be assigned a predetermined value based on the selection of a vehicle mode by a user. According to this example, the tuning parameter may have a first value for a sport mode, a second different value for a comfort mode, a third different value for an economical mode, or any other appropriate value for any number or type of vehicle modes that may be defined for a vehicle. In some embodiments, to provide a vehicle performance that better matches a user's desired subjective experience, it may be desirable to permit a user to modify a tuning parameter associated with a particular vehicle mode. In one such embodiment, a user may input a tuning parameter directly or otherwise adjust the value of the tuning parameter for one or more vehicle modes. For example, a tuning parameter may have a predetermined range for a vehicle mode within which a user can select a particular value to fine tune the preferred feel of the vehicle. In some embodiments, a tuning parameter may be adjusted within the predetermined range according to feedback from the user input at an input device. For instance, requests for more chassis and/or vehicle body isolation or more road tracking control by a user may result in a corresponding change of the associated tuning parameter(s) within the predetermined range to provide the desired change in vehicle performance.

In some embodiments, in a comfort mode, a tuning parameter of a vehicle control system may be assigned such that isolation control is favored. That is, a control scheme where more skyhook control is implemented is favored. In some embodiments where the tuning parameter is a crossover frequency and a complementary filter is employed, the crossover frequency may be lower relative to other vehicle modes. In some embodiments, in a comfort mode the crossover frequency may be assigned a lowermost value. As noted above, in a complementary filter a first input may be the dominant input in the content below the crossover frequency, and a second input is the dominant input in the content above the crossover frequency. Accordingly, a blended input may be determined where the content of input for frequencies below the crossover frequency may be dominated by the first input, and the content of input for frequencies above the crossover frequency are dominated by the second input. By lowering the crossover frequency in the comfort mode, the blended input is dominated by the second input as compared to the first input. The second input may be a vehicle parameter relating to motion of a chassis and/or vehicle body of the vehicle (e.g., chassis and/or vehicle body velocity), whereas the first input may be a vehicle parameter relating to motion of a suspension of the vehicle (e.g., suspension velocity). Accordingly, setting the crossover frequency to a lowermost value may make chassis and/or vehicle body motion information dominant as a blended input into a vehicle control system for determining forces to apply with one or more actuators of the suspension system. In some embodiments, a crossover frequency for a comfort mode may be, for example, approximately 0.2 Hz, or between 0.1 and 0.5 Hz. As a result, the overall control of the vehicle will favor isolation of the vehicle chassis and/or vehicle body. In some optional embodiments, a comfort mode may also include increasing a damping gain that is applied after a blended input parameter is determined based on the crossover frequency (or other tuning parameter) relative to other vehicle modes. The increase of the damping gain may create an overdamped control module that better reduces the motion of the chassis and/or vehicle body compared to other modes. In some optional embodiments, a phase lead filter may be employed to increase isolation at secondary ride frequencies (e.g., at frequencies approximately equal to or greater than 3 Hz and less than or equal to 10 Hz). Other frequencies for a crossover frequency and phase lead filter both greater than and less than those noted above are also contemplated, as the present disclosure is not so limited.

In some embodiments, in a sport mode a tuning parameter of a vehicle control system may be assigned such that tracking control is more favored. That is, a control scheme where more groundhook control is implemented is favored. In some embodiments where the tuning parameter is a crossover frequency and a complementary filter is employed, the crossover frequency may be higher relative to other vehicle modes. In some embodiments, in a sport mode the crossover frequency may be assigned an uppermost value. As noted above, in a complementary filter a first input may be the dominant input in the content below the crossover frequency, and a second input is the dominant input in the content above the crossover frequency. Accordingly, a blended input may be determined where the content of input for frequencies below the crossover frequency may be dominated by the first input, and the content of input for frequencies above the crossover frequency are dominated by the second input. By raising the crossover frequency in the sport mode, the blended input is dominated by the first input as compared to the second input. The second input may be a vehicle parameter relating to motion of a chassis and/or vehicle body of the vehicle (e.g., chassis and/or vehicle body velocity), whereas the first input may be a vehicle parameter relating to motion of a suspension of the vehicle (e.g., suspension velocity). Accordingly, setting the crossover frequency to an uppermost value may make suspension motion information dominant as a blended input into a vehicle control system for determining forces to apply with one or more actuators of the suspension system. In some embodiments, a crossover frequency for a sport mode may be approximately 3 Hz, or between 1 and 4 Hz. As a result, the overall control of the vehicle will favor ground tracking for the vehicle chassis and/or vehicle body, at least as compared to the comfort mode. In some embodiments, the overall control of the vehicle may still implement some chassis and/or vehicle body isolation, control, but less isolation and more ground tracking. The inventors have recognized that by performing a frequency blend of suspension velocity and inertial velocity according to a crossover frequency, it is possible to reduce high frequency noise in the final control signal. However, the advantages of favoring suspension velocity as an input at lower frequencies are not lost. In the sport mode, the vehicle control system can deliver a sport feel at primary ride frequencies (e.g., at frequencies between 0 and 3 Hz) without the accompanying secondary ride degradation (e.g., at frequencies between 3 and 12 Hz), unlike conventional suspension systems. In some optional embodiments, a sport mode may also include applying a damping gain that creates a critically damped control module. This damping gain may be less than that of a comfort mode. In some optional embodiments, a low pass filter may be employed in a sport mode to raise the apparent natural frequency of the system. In some embodiments, the low pass filter may be applied at a frequency of, for example, approximately 3 Hz. Other frequencies for a crossover frequency and low pass filter both greater than and less than those noted above are also contemplated.

In some embodiments, in an economical or “eco” mode a tuning parameter of a vehicle control system may be assigned such that less energy is used by actuators of a suspension system. That is, a control scheme where a blend of isolation and tracking control is implemented requiring application of less active force is favored. In some embodiments where the tuning parameter is a crossover frequency and a complementary filter is employed, the crossover frequency may be between other vehicle modes (e.g., between a sport mode and a comfort mode). As noted above, in a complementary filter a first input may be the dominant input in the content below the crossover frequency, and a second input is the dominant input in the content above the crossover frequency. Accordingly, a blended input may be determined where the content of input for frequencies below the crossover frequency may be dominated by the first input, and the content of input for frequencies above the crossover frequency are dominated by the second input. By assigning a middle frequency in the economical mode between the frequencies assigned to the sport mode and comfort mode, the blended input is not dominated by either the first input or the second input, but rather the two inputs contribute relatively equally to the overall blended input for primary ride frequencies (e.g., between 0 and 3 Hz). The second input may be a vehicle parameter relating to motion of a chassis and/or vehicle body of the vehicle (e.g., chassis and/or vehicle body velocity), whereas the first input may be a vehicle parameter relating to motion of a suspension of the vehicle (e.g., suspension velocity). Accordingly, setting the crossover frequency to a middle value may allow both suspension motion information and chassis and/or vehicle body motion information to be combined into a blended input for determining forces to apply with one or more actuators of the suspension system. In some embodiments, a crossover frequency for an economical mode may be approximately 1 Hz, or between 0.5 and 2 Hz. As a result, the overall control of the vehicle will implementing combined isolation control and ground tracking for the vehicle chassis and/or vehicle body, at least as compared to the comfort and sport modes. The inventors have recognized that by performing a frequency blend of suspension velocity and inertial velocity according to a middle crossover frequency, it is possible to reduce the energy expended by one or more actuators of a suspension system. In some optional embodiments, an economical mode may also include applying a low damping gain that creates an underdamped control module, which further reduces energy usage of one or more actuators. In some embodiments, in an economical mode no additional linear filters may be applied to a blended input.

In some embodiments, the inputs to various control modules described herein may be provided by one or more sensors onboard a vehicle or from on-board or remote databases. In some cases, multiple sensors and/or redundant sensors may be employed to provide information (e.g., current and/or preview information) from which a force command may be determined by a control module (e.g., via proportional, integral, and/or derivative control). Sensors may provide information associated with different components of the vehicle, including e.g., wheels or wheel assemblies, suspension components, chassis and/or vehicle body components, user interface components, transmission components, engine components, etc. In some embodiments, one or more accelerometers may be employed to provide acceleration information regarding a vehicle component. For example, an accelerometer may be disposed on the chassis and/or vehicle body may be provide chassis and/or vehicle body acceleration information or chassis and/or vehicle body velocity information (e.g., via the integral of the acceleration). In some embodiments, information from one or more accelerometers on the chassis and/or vehicle body may be employed to determine inertial heave, pitch and roll velocity of the chassis and/or vehicle body, each of which are parameters that may be employed for skyhook control. As another example, one or more accelerometers may be disposed on one or more components of a vehicle suspension and/or wheel assembly and may be configured to provide suspension acceleration information (e.g., in a direction of travel such as a vertical direction) and suspension velocity information (e.g., via the integral of the acceleration or via the derivative of position from a position sensor). In some embodiments, information from one or more accelerometers on the suspension may be employed to determine suspension heave, pitch and roll velocity with respect to the road surface, each of which are parameters that may be employed for groundhook control. Other sensors may also be employed, including encoders, potentiometers, displacement sensors, distance sensors, and/or other appropriate types of sensors on any appropriate portion of a vehicle to sense position, velocity, and/or acceleration information of the associated portion of the vehicle. In some embodiments, a suspension actuator may provide feedback information to a control module regarding its force output, position, velocity, and/or acceleration. For example, suspension velocity information may be determined based on a derivative of a position sensor of the suspension actuator. In view of the above, any suitable inputs and sensors may be employed as inputs for control modules described herein, as the present disclosure is not so limited.

In some embodiments, control modules described herein may be vehicle level control modules. That is, the control modules may output an overall force command for the suspension system to execute. A suspension may include one or more actuators, and this overall force command may be allocated to individual actuators to achieve the overall force command and desired overall response of the vehicle chassis and/or vehicle body. In some embodiments, methodologies described herein may be applicable to control of a vehicle at a per-corner or per-actuator level following the blending process for control module inputs described according to exemplary embodiments herein. Corresponding to the described vehicle level control, in some embodiments inputs to the control modules described herein may also be at the vehicle level. For example, in some embodiments, information from individual sensors (e.g., associated with an individual wheel or actuator) may be combined with information from other sensors to provide overall information regarding the motion of the overall vehicle chassis and/or vehicle body or overall vehicle suspension system. For example, individual inputs regarding a suspension system associated with a single wheel or wheel assembly may be averaged with the other wheels or wheel assemblies of the vehicle to obtain a per-corner average input that is provided to a vehicle level control module. Any suitable method of combining information from multiple sensors may be employed to obtain overall information provided to a control module, including, but not limited to, summing, averaging, matrix multiplication, and/or any other appropriate method for combining the information.

According to exemplary embodiments herein, “skyhook” may refer to control seeking to isolate a vehicle chassis and/or vehicle body from external disturbances regardless of the profile of the underlying road surface. For example, under perfect skyhook control a vehicle chassis and/or vehicle body may experience no accelerations in roll, pitch, and/or heave. It should be understood that when skyhook control is implemented by an actual active suspension system, depending on the magnitude and frequency of a road input to a vehicle from a corresponding feature on a road surface, the active suspension system may only mitigate a portion of the road input such that the vehicle chassis and/or vehicle body is still subject to some force/acceleration due to the road input. However, this force/acceleration may be reduced as compared to situations in which the skyhook control is not applied.

According to exemplary embodiments herein, “groundhook” may refer to control seeking to maintain a fixed distance between a vehicle chassis and/or vehicle body and the underlying road surface. For example, the distance between a wheel or wheel assembly and the vehicle chassis and/or vehicle body under perfect, or effectively perfect, groundhook control may remain constant, or effectively constant. It should be understood that when groundhook control is implemented by an actual active suspension system, depending on the magnitude and frequency of a road input to a vehicle from a corresponding feature on a road surface, the active suspension system may not maintain a constant distance between the chassis and/or vehicle body and road surface. Instead, some variations from the target distance may be experienced, though these variations from the target distance may be reduced as compared to situations in which the groundhook control may not be applied.

In some embodiments, the implementation of skyhook or groundhook control may be dependent on the value of a tuning parameter and a resulting blended input. For example, the same control module may implement either skyhook or groundhook control depending on the content of the input to the control module or control system. According to this example, favoring more input from a suspension system may favor groundhook control, whereas favoring more input from a chassis and/or vehicle body of the vehicle may favor more isolation control. The same control module otherwise performing the same function may seek to reduce motion of the suspension system (e.g., groundhook) or reduced motion of the chassis and/or vehicle body (e.g., skyhook) based on the input to the control module. The weightings of the two inputs into the blended input may be automatically determined according to the tuning parameter, for example, by a complementary filter.

According to exemplary embodiments herein, control methodologies described herein may be applicable for controlling motion of a vehicle chassis and/or vehicle body in one or more degrees of freedom. In some embodiments, a control methodology including a tuning parameter may be implemented for controlling heave, pitch, and/or roll of a vehicle chassis and/or vehicle body. In some embodiments, an overall force command may be configured to modify the heave, pitch, and/or roll motion of the chassis and/or vehicle body, and the overall force command may be allocated to individual actuators to achieve the overall control objective. In some embodiments, control methodologies described herein may be applied to a single degree of freedom of a vehicle chassis and/or vehicle body (e.g., one of pitch, roll, and heave). In some embodiments, multiple control modules may be implemented for each degree of freedom of the vehicle chassis and/or vehicle body, such that each degree of freedom may be assigned an independent tuning parameter that may be adjusted according to vehicle mode. In other embodiments, control methodologies described herein may be employed to control other vehicle motion parameters, as the present disclosure is not so limited.

According to exemplary embodiments herein, the processes described may be formed as blocks of a linear control module. Thus, various processes described herein may be reordered within the linear control module. For example, a damping gain and/or filter such as a phase lead or low pass filter may be applied prior to a complementary filter for determining a blended input. Accordingly, processes described in an exemplary order herein may be reordered in some embodiments, as the present disclosure is not so limited.

It should be noted that the control methodologies described herein may implement frequency blending of distinct inputs. That is, a blended input may be determined based on one or more frequency filters applied to input information. Accordingly, embodiments described herein may be applicable to active suspension systems where an active force may be applied by one or more actuators of the active suspension system. Such systems may implement frequency blending in feedback control as active forces are applied by the suspension system. In contrast, passive or semi-active suspension systems where no active forces are applied may not be able to implement frequency blending according to exemplary embodiments herein.

According to embodiments herein, a vehicle may include a chassis and/or vehicle body and one or more wheels or wheel assemblies (e.g., four wheels or wheel assemblies) supporting the chassis and/or vehicle body. The vehicle may include an active suspension system operatively interposed between the one or more wheels or wheel assemblies and the chassis and/or vehicle body. The active suspension system may be configured to adjust a normal force between any one or more of the wheels of the vehicle and the ground (e.g., via a tire) by applying force between the wheel or wheel assembly and a chassis and/or vehicle body of the vehicle. The active suspension system may be configured to generate extension or compression of a suspension assembly main spring, in some embodiments. The forces applied between the wheels or wheel assemblies and the chassis and/or vehicle body may be transferred to the chassis and/or vehicle body through the active suspension system, allowing the active suspension system to control one or more motion parameters of the vehicle chassis and/or vehicle body. Vehicle motion parameters, may include, but are not limited to, rotations about various axes (e.g., roll and pitch). Vehicle motion parameters may also include, but are not limited to, translation along various axes (e.g., translation along a vertical z-axis otherwise referred to as “heave”). In some embodiments, three Cartesian principal axes may be established relative to a supporting surface underneath a vehicle (e.g., a plane). In some embodiments, the three cartesian principal axes may be established relative to a direction of local gravity when the vehicle is disposed on level ground. As discussed further below, the active suspension system may control one or more vehicle motion parameters of the chassis or the body of the vehicle by applying active or passive forces between the chassis and/or vehicle body and one or more wheels or wheel assemblies. Changing the force output by the active suspension system may alter the one or more vehicle motion parameters. In some embodiments, a vehicle may include at least one processor configured to execute computer readable instructions stored in associated volatile or non-volatile memory that when executed perform any of the methods disclosed herein. In some embodiments, the at least one processor may be configured to control the active suspension system to control the one or more vehicle motion parameters of the chassis and/or vehicle body. In some embodiments, the at least one processor may be operated as a part of one or more control modules of the vehicle.

In some embodiments, an active suspension system may be configured to be operatively interposed between one or more wheels or wheel assemblies and a chassis and/or vehicle body of a vehicle. The active suspension system may include one or more actuators configured to be associated with the one or more wheels or wheel assemblies. For example, the active suspension system may include at least one actuator at each wheel or wheel assembly of the vehicle. In some embodiments, an actuator of an active suspension system comprises a hydraulic device operatively coupled with an electric motor/generator. The term hydraulic device may refer to either a hydraulic motor, a hydraulic pump, a hydraulic motor being operated as a pump, and/or a hydraulic pump being operated as a hydraulic motor. A hydraulic device may be capable of providing fixed displacements, variable displacements, fixed velocities, and/or variable velocities as the disclosure is not limited to any particular device. Appropriate types of hydraulic devices may include, but are not limited to, gerotor pumps, vane pumps, gear pumps, screw pumps, and/or any other appropriate type of hydraulic device. The term electric motor/generator may refer to either an electric motor and/or an electric generator. In either case, in some embodiments, an associated hydraulic device may drive the electric motor/generator such that it functions as a generator to provide damping to a hydraulic actuator while also generating electrical energy in at least one mode of operation. The electric motor/generator may also drive the hydraulic device as a pump to create a flow of fluid to drive operation of the actuator and/or resist movement of a piston of the actuator in at least one mode of operation. Depending on the particular embodiment, an electric motor/generator may be operated only as a generator, only as a driven motor, and/or as both depending on the particular application. Appropriate types of electric motor/generators may include, but are not limited to, a brushless DC motor, a brushed DC motor, an induction motor, a dynamo, or any other type of device capable of converting electricity into rotary motion and/or vice-versa. The actuator may be configured to apply active forces and/or passive forces (which may also be referred to as damping forces herein) between a wheel or wheel assembly of the vehicle and the chassis and/or vehicle body of the vehicle. The application of active and/or passive forces may be employed to control a motion of the chassis and/or vehicle body and/or wheel. In some embodiments, an active suspension system may include one or more physical springs or dampers, which may apply passive forces to the one or more wheels or wheel assemblies and the chassis and/or vehicle body of the vehicle.

While an actuator of an active suspension system disclosed above is described as including a hydraulic device and an electric motor/generator, the current disclosure is not limited to any particular type of active suspension system. Accordingly, other appropriate types of active suspension systems including different types of actuators may also be used. For example, electrical actuators such as solenoid-based actuators, actuators using linear electric motors, hydraulic actuators associated with a central pressure source (e.g., a pump) and associated valves, and/or any other appropriate type of actuator capable of being used to operate an active suspension system may be used with the various embodiments disclosed herein as the disclosure is not so limited.

As used herein an “active force” is a force that is generated by a vehicle suspension system, and that is oriented at least partially in the direction of motion at the point of application of the force on an associated structure. For example, an active force may include applying force to a wheel or wheel assembly in a direction of motion of the wheel or wheel assembly via an active suspension system actuator. As used herein a “passive force”, “damping force”, or other similar term may be a force that may be applied on a structure in a direction that at least partially opposes the motion at the point of application of the force. For example, a suspension system actuator may generate a damping force (e.g., forces that resist movement of a wheel or wheel assembly and/or vehicle body) in response to a wheel or wheel assembly being moved by a road feature, though it is noted that an active suspension system may also apply damping forces that resist motion of an associated mass. For example, in some embodiments an actuator may apply a damping force in a direction that is at least partially opposite a direction of motion of the component being damped. According to exemplary embodiments described herein, certain vehicle systems (e.g., active suspension systems) may apply active and/or passive forces depending on a mode of operation of the vehicle system. For example, an active suspension system may be operated in a first mode where an actuator is employed to apply active forces to one or more portions of the vehicle (e.g., a chassis and/or vehicle body and wheel or wheel assembly of the vehicle) and in a second mode where only passive forces are applied in response to external force inputs on the vehicle. In some operational modes, vehicle systems, including active suspension systems, may generate both active and passive forces.

As used herein, a “road event” is any event that may occur while a vehicle is traveling on a roadway. In some embodiments, a road event may include encountering a road feature. A “road feature” is any non-nominal road condition that may be encountered by a vehicle while traveling on a road surface. For example, a road feature may include, but is not limited to rough pavement, potholes, manhole covers, storm drains, bumps, uneven lanes, variable road materials (e.g., dirt, gravel, pavement, concrete, metal, etc.), road coverings (e.g., snow, ice, salt, sand, dirt, water, etc.), and/or any other appropriate feature that may involve changes in the forces applied to a vehicle traversing a road surface. In some embodiments, a road event may include a turn (e.g., traversing a corner) or a baking event (e.g., applying one or more brakes to decelerate the vehicle).

According to exemplary embodiments described herein, a vehicle control system, control module, or other appropriate system may be operated by one or more processors. The one or more processors may be configured to execute computer readable instructions stored in volatile or non-volatile memory. The one or more processors may communicate with one or more actuators associated with various systems of the vehicle (e.g., braking system, active suspension system, steering system, rear steering system, driver assistance system, etc.) to control activation and movement of the various systems of the vehicle. The one or more processors may receive information from one or more sensors that provide feedback regarding the various systems of the vehicle. For example, the one or more processors may receive position information regarding the vehicle from a Global Navigation Satellite System (GNSS) or other positioning system. The sensors on board the vehicle may include, but are not limited to, wheel rotation speed sensors, accelerometers, inertial measurement units (IMUs), optical sensors (e.g., cameras, LIDAR), radar, suspension position sensors, gyroscopes, and/or any other appropriate type of sensor. In this manner, the vehicle control system may implement proportional control, integral control, derivative control, a combination thereof (e.g., PID control), or other control strategies of various systems of the vehicle. Other feedback or feedforward control schemes are also contemplated, and the present disclosure is not limited in this regard. Any suitable sensors in any desirable quantities may be employed to provide feedback information to the one or more processors. Information from sensors may be employed in coordination with desirable processing techniques (e.g., machine vision). The one or more processors may also communicate with other control modules, computers, and/or processors on a local area network, a controller area network (CAN), wide area network, a cloud-based database, or internet using an appropriate wireless or wired communication protocol. It should be noted that while exemplary embodiments described herein are described with reference to a single processor, any suitable number of processors may be employed as a part of a vehicle, as the present disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

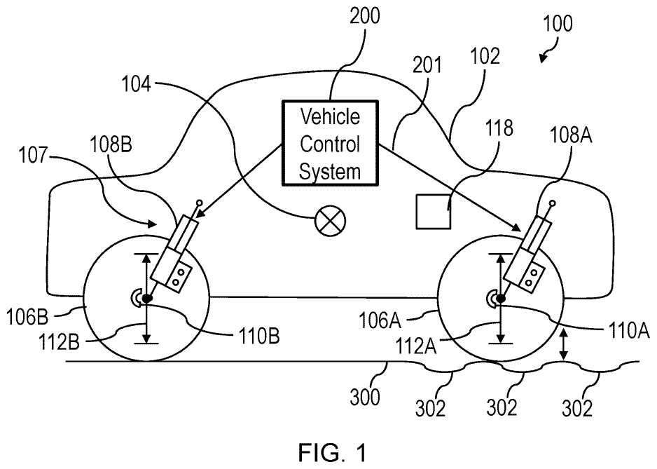

FIG. 1 is a schematic of one embodiment of a vehicle 100. The vehicle includes a chassis and/or vehicle body 102 that supports the various components of the vehicle. The vehicle 100 includes a first wheel 106A and a second wheel 106B operatively coupled to the chassis and/or vehicle body 102. The first wheel 106A and the second wheel 106B may be driven by a propulsion system (e.g., internal combustion engine, electric motor, etc.). The chassis and/or vehicle body 102 may be representative of a sprung mass of the vehicle sprung from the first wheel 106A and the second wheel 106B. The first wheel or wheel assembly 106A and the second wheel or wheel assembly 106B may be unsprung masses of the vehicle. While two wheels or wheel assemblies are shown in the embodiment of FIG. 1, in some embodiments a vehicle may include two, three, four, five, six, or any other number of wheels or wheel assemblies, as the present disclosure is not so limited.

As shown in FIG. 1, the vehicle 100 includes a vehicle control system 200 that may communicate with various subsystems via a communication system 201. As shown in FIG. 1, the vehicle 100 includes an active suspension system 107 that is operatively interposed between the first wheel 106A or the associated wheel assembly and second wheel 106B or the associated wheel assembly (e.g., an unsprung mass) of the vehicle and the chassis and/or vehicle body 102 (e.g., sprung mass). The first wheel 106A and the second wheel 106B may be representative of associated wheel assemblies. For example, in some cases, an active suspension system 107 may be coupled to a wheel assembly or other intermediate component, rather than directly to a wheel. As shown in FIG. 1, the active suspension system 107 includes one or more active suspension actuators 108A, 108B may be operatively interposed between each wheel or wheel assembly 106A, 106B of the vehicle and the vehicle chassis or body, such that separate actuators of the active suspension may independently control the notion of each of the wheels or wheel assemblies of the vehicle. In the embodiment of FIG. 1, a first actuator 108A is coupled to the first wheel 106A, and a second actuator 108B is coupled to the second wheel 106B. The actuators 108A, 108B may be configured to apply force between the wheels 106A, 106B and the chassis and/or vehicle body 102 to adjust a normal component of force between the wheels and a road surface 300 by applying an active extension or compression force on the wheels or wheel assemblies and the chassis and/or vehicle body. Such an application of force by the actuators 108A, 108B may affect a motion response of the chassis and/or vehicle body 102, and in particular one or more vehicle motion characteristics.

As shown in the embodiment of FIG. 1, the vehicle 100 may also include a braking system including a first brake 110A and a second brake 110B. The first brake 110A may be coupled to the first wheel 106A and the second brake 110B may be coupled to the second wheel 106B. In the embodiment of FIG. 1, the braking system includes independent brakes coupled to each of the vehicle wheels 106A, 106B, such that a braking force may be applied to each wheel independently.

As shown in FIG. 1, the vehicle may traverse over a road surface 300. The road surface 300 may include one or more road features 302. The road features 302 may cause fluctuations in the normal load of a wheel 106A, 106B of the vehicle 100 (e.g., by accelerating the wheel, and associated wheel assembly, upward and/or downward). In some embodiments, a road feature 302 may produce a chassis and/or vehicle body motion response of the vehicle based on one or more vehicle motion characteristics of the chassis and/or vehicle body 102. For example, a road feature 302 may introduce a roll motion, pitch motion, heave motion, or torsional motion in the vehicle chassis and/or vehicle body 102 that may be perceptible by a user of the vehicle 100. The vehicle control system 200 may control the active suspension system 107 and the force applied by each of the actuators 108A, 108B to provide desired vehicle motion characteristics in response to the disturbance caused by the road feature 302. As discussed further below, force may be allocated to achieve a desired level of isolation of the chassis and/or vehicle body 102 from the disturbances to improve user comfort within the vehicle.

It should be noted that the vehicle of FIG. 1 is simplified for the sake of explanation. A vehicle 100 may include any number of systems affecting the dynamics of the vehicle and its response to disturbances from road features 302. For example, user input devices such as steering, throttle, and braking may affect the response of a vehicle based on the user input. The vehicle control system may include at least one processor configured to execute computer readable instructions and control one or more vehicle outputs. For example, the vehicle control system 200 may include at least one processor configured to receive input from the user and command one or more systems of the vehicle to perform certain actions (e.g., acceleration, deceleration, steering). In some embodiments, the vehicle control system 200 may include an electronic stability control system and anti-lock braking system (ABS). The electronic stability control system may be configured to automatically apply the brakes 110A, 110B to help steer the vehicle where the driver intends to go when there is a loss of traction. The ABS is configured to inhibit wheels from locking up and sliding. The vehicle control system 200 may receive a plurality of inputs from a variety of vehicle sources, including, but not limited to, user input, sensors attached to a sprung mass of the vehicle, sensors attached to an unsprung mass of a vehicle, feedback from one or more actuators, or any combination of the foregoing. The vehicle control system 200 may employ the plurality of inputs to determine one or more outputs (e.g., force commands) to one or more systems of a vehicle (e.g., active suspension system 107, brakes 110A, 110B, throttle, etc.) to achieve a desired vehicle response. Exemplary operational modes and control schemes for the vehicle control system 200 are discussed further below.

In some embodiments as shown in FIG. 1, the vehicle 100 may include a real-time bi-directional communication system 201 that enables communication between the various subsystems and vehicle outputs. The communication system 201 may employ any appropriate connection protocol including, for example, a controller area network (CAN), a local interconnect network (LIN), a vehicle area network (VAN), FlexRay, D2B, Ethernet, a direct communication link (such as wires and optical fibers), or a wireless communication link. The communications system may be employed to share information between subsystems, like ABS or ESC, while receiving vehicle state parameters or other information from these same or other systems. Information that may be shared between subsystems and employed for vehicle output control includes, but is not limited to, for example, vehicle yaw and yaw rate, vehicle velocity, vehicle acceleration, vehicle lateral acceleration, steering wheel or wheel assembly position, steering wheel or wheel assembly torque, if the brakes are being applied, suspension spring compression, chassis and/or vehicle body heave velocity, and wheel or wheel assembly heave velocity. The vehicle control system 200 may control the active suspension system 107 based on information from the vehicle such as the state of one or more vehicle subsystems, such as ABS and ESC, which engage during unusual events. For example, the system may provide different control of the wheels or wheel assemblies and vehicle if one or more systems are engaged.

In some embodiments an active suspension system 107 may sense several parameters relating to the road, wheel, vehicle body movement, and/or other parameters that may benefit other vehicle subsystems. Such information may be transmitted from the active suspension system to the vehicle control system 200 and the other subsystems via the communication system 201. Other vehicle subsystems may alter their control based on information from the active suspension system. As such, bidirectional information may be communicated between the active suspension system 107 and other subsystems, and control of both the active suspension system and the other vehicle systems may be provided based at least partially on this information transfer. In some embodiments, the communication system 201 may include a transceiver configured to send or receive information. -25 In some embodiments, the vehicle control system 200 may include a forward-looking sensor. The forward-looking sensor may sense road characteristics, road features, or objects in front the vehicle 100, which may be provided to the at least one processor as forward-looking road information. In the embodiment of FIG. 1, the vehicle control system may also include reference road information that may be stored in memory onboard the vehicle control system 200 or at a remote location. In some embodiments, forward looking information may be employed in control of the vehicle 100, for example, to reduce or eliminate undesirable motion of the chassis and/or vehicle body 102.

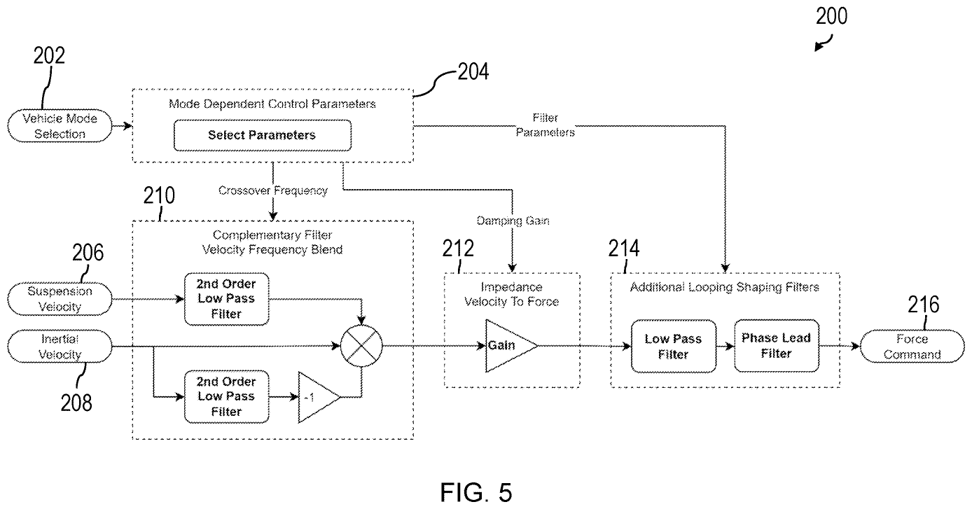

In some embodiments, a vehicle may include a user interface 118 through which the user may provide user input to affect the control of the vehicle. In the embodiment of FIG. 1, the user interface 118 may include a touch screen of an infotainment unit. In other embodiments, a user interface may include a touch screen, steering wheel, buttons, switches, microphone (e.g., for voice commands), keyboard, pedals, or any other suitable input device. The user interface 118 may be configured to receive input from a user that may be employed to update one or more parameters (e.g., a tuning parameter) for control of the various subsystems of the vehicle, including the active suspension system. In some embodiments, a user may provide user input at the user interface 118 to select an operating mode (e.g., comfort, sport, etc.). Based on the mode selected, various control parameters of the vehicle may change, including, but not limited to, a tuning parameter for determining a bended input to an active suspension system control module, engine tuning, throttle response, braking response, steering response, and suspension control. For example, the user input may be employed to update a crossover frequency for a complementary filter used to combine two inputs into a blended input, as discussed further below with reference to the embodiments of FIGS. 5-8.

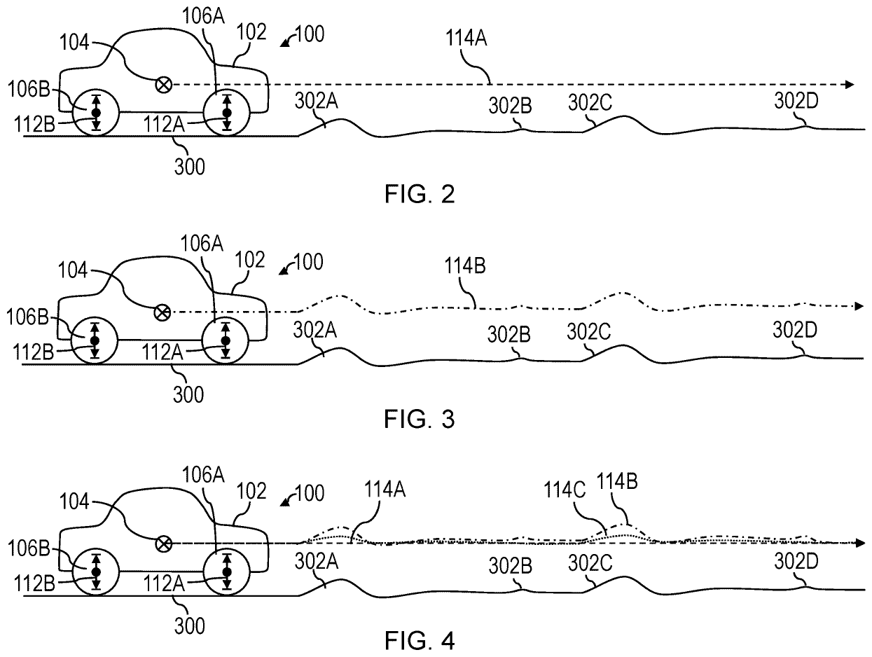

In some embodiments, the vehicle control system 200 is configured to control the various vehicle subsystems including the active suspension system 107. In particular, as will be discussed further below with reference to FIGS. 2-4, the vehicle control system may be configured to determine a force command for the actuators 108A, 108B of the active suspension system to control vehicle motion parameters of the chassis and/or vehicle body 102. For example, the vehicle control system 200 may command the actuators 108A, 108B to generate forces and/or movements of the wheels or wheel assemblies 106A, 106B to achieve a desired motion or isolation of the chassis and/or vehicle body 102 that will be perceptible to an occupant of the chassis and/or vehicle body. In one operating mode, the vehicle control system 200 commands the actuators 108A, 108B to at least partially isolate the chassis and/or vehicle body from accelerations caused by external disturbances (e.g., caused by road features 302). In such an operating mode, the wheels or wheel assemblies 106A, 106B may move relative to the chassis and/or vehicle body 102 within their respective ranges of motion 112A, 112B to at least partially compensate for the forces that may otherwise be transmitted to the vehicle chassis and/or vehicle body by the road features 302 or due to inertial forces may be induced by the acceleration of the vehicle. In some embodiments, the vehicle control system 200 may determine outputs of the actuators 108A, 108B based on multiple inputs of different vehicle parameters. For example, the vehicle control system 200 may determine actuator outputs based on a blended input including components from a suspension motion parameter (e.g., suspension velocity) and a chassis and/or vehicle body motion parameter (e.g., chassis and/or vehicle body velocity). Depending on a particular tuning parameter, the contributions of each input may change, affecting the overall output of the control system. For example, the frequency range assigned to each input may change based on the tuning parameter. Exemplary tuning parameters and their effect on the control of the motion parameters of the chassis and/or vehicle body 102 are discussed further with reference to FIGS. 2-4.

FIG. 2 is a schematic of an embodiment of a vehicle 100 under chassis and/or vehicle body isolation control with a tuning parameter employing input based on a chassis and/or vehicle body motion parameter (e.g., chassis and/or vehicle body velocity). In the embodiment of FIG. 2, a vehicle control system has implemented a control scheme that may seek to reduce motion of the portion of the vehicle contributing input. The vehicle control system may be operated based on feedback including a first input and a second input. The first input may be a suspension motion parameter such as suspension velocity, and the second input may be a chassis and/or vehicle body motion parameter such as chassis and/or vehicle body velocity. The two inputs may be blended based on a tuning parameter (e.g., a single tuning parameter). In some embodiments, the tuning parameter may be a crossover frequency which establishes a frequency threshold where frequencies below the crossover frequency are contributed by the first input (e.g., suspension motion parameter) and frequencies above the crossover frequency are contributed by the second input (e.g., chassis and/or vehicle body motion parameter). In this manner, the blended input is a frequency blend of the first and second input, with the precise blend being affected by the tuning parameter. Lower frequencies may be assigned to the suspension motion parameter, and higher frequencies may be assigned to the chassis and/or vehicle body motion parameter, depending on the set point established by the tuning parameter. Increasing the tuning parameter may mean more of the blended input frequency space is contributed by the suspension motion parameter, resulting in the vehicle control system seeking to implement more groundhook control. Decreasing the tuning parameter may mean more of the blended input frequency space is contributed by the chassis and/or vehicle body motion parameter, resulting in the vehicle control system seeking to implement more skyhook control. In some embodiments, the tuning parameter may be predetermined for a particular vehicle mode. In some embodiments, the tuning parameter may be received as user input (e.g., via a user interface of the vehicle 100).

In the example of FIG. 2, the selected tuning parameter may result in a chassis and/or vehicle body motion parameter such as chassis and/or vehicle body velocity making a larger contribution to a blended input as compared to a suspension motion parameter such as suspension velocity. For example, the tuning parameter may be a crossover frequency of approximately 0.3 Hz. According to this example, the frequency content of the input to the vehicle control system below 0.3 Hz will be based on the suspension motion parameter, and above 0.3 Hz will be based on the chassis and/or vehicle body motion parameter. As a result of the chassis and/or vehicle body motion parameter being favored by the tuning parameter, the vehicle control system seeks to avoid or minimize accelerations of the chassis and/or vehicle body 102 for one or more motion parameters (e.g., pitch, roll, and/or heave), because the input is primarily driven by the chassis and/or vehicle body motion parameter. For example, in a vertical heave direction, the vehicle control system, in certain modes, may seek to maintain a center of mass 104 of the vehicle within a horizontal plane as the vehicle travels along a road surface. As illustrated in FIG. 2, an isolation control line 114A is representative of an idealized goal of the vehicle control system based on an input of only chassis and/or vehicle body motion parameter (e.g., the blended input is based solely on the chassis and/or vehicle body motion parameter) in controlling the heave motion parameter of the vehicle chassis and/or vehicle body 102 as the vehicle moves along the road surface 300. The isolation control line 114A is horizontal relative to the page, such that the chassis and/or vehicle body 102 does not move up or down (e.g., in a heave direction), or effectively does not move up or down, in response to road features. The isolation control line 114A may be representative of the heave motion parameters of the chassis and/or vehicle body, though the vehicle control system may also control other motion parameters similarly. For example, the chassis and/or vehicle body pitch (e.g., rotation clockwise or counterclockwise about the center of mass 104 relative to the page) may also have a goal of being held constant, effectively constant, or substantially constant where an input is solely a chassis and/or vehicle body motion parameter.

As shown in FIG. 2, the vehicle includes a first wheel or wheel assembly 106A and a second wheel or wheel assembly 106B that support the chassis and/or vehicle body 102 (and other sprung mass) on the road surface 300. The first wheel or wheel assembly 106A and the second wheel or wheel assembly 106B are coupled to the chassis and/or vehicle body 102 via an active suspension system (for example, see FIG. 1). The first wheel or wheel assembly 106A is movable relative to the chassis and/or vehicle body 102 in a first range of motion 112A. The position of the first wheel or wheel assembly 106A within the first range of motion 112A may be controlled by, e.g., passive and active components, including actuators and springs. In particular, the first wheel or wheel assembly 106A may be controlled via an actuator of the active suspension system that may apply forces to the first wheel or wheel assembly 106A to achieve a desired position of the first wheel or wheel assembly relative to the chassis and/or vehicle body 102. The actuator may apply forces between the chassis and/or vehicle body 102 and the first wheel or wheel assembly 106A to obtain the desired position and also impart forces to the chassis and/or vehicle body to control the motion of the chassis and/or vehicle body. Similarly, the second wheel or wheel assembly 106B is movable relative to the chassis and/or vehicle body 102 in a second range of motion 112B. The position of the second wheel or wheel assembly 106B within the second range of motion 112B may be controlled by passive and active components, including actuators, and springs. In particular, the second wheel or wheel assembly 106B may be controlled via an actuator of the active suspension system that may apply forces to the second wheel or wheel assembly 106B to achieve a desired position of the second wheel or wheel assembly relative to the chassis and/or vehicle body 102. The actuator may apply forces between the chassis and/or vehicle body 102 and the second wheel or wheel assembly 106B to obtain the desired position and also impart forces to the chassis and/or vehicle body to control the motion of the chassis and/or vehicle body.

According to the example of FIG. 2, the road surface 300 includes a plurality of road features 302A, 302B, 302C, 302D. These road features are representative of bumps or variations in an otherwise smooth road surface that will impart forces to the vehicle 100 when contacted by the first wheel or wheel assembly 106A and the second wheel or wheel assembly 106B. In conventional vehicle suspensions, springs and dampers would soften or delay force transmission to the chassis and/or vehicle body 102. However, a passive suspension system may transfer some force to the vehicle chassis and/or vehicle body 102, resulting in a deviation of the center of mass 104 from the idealized isolation control line 114A. In active suspension systems, active forces countering the forces imparted to the wheel or wheel assembly by the road features 302A, 302B, 302C, 302D may reduce or eliminate forces imparted to the chassis and/or vehicle body 102 that would cause a deviation from the idealized isolation control line 114A. For example, rather than maintaining a fixed distance between the first wheel or wheel assembly 106A and the chassis and/or vehicle body 102 when the first wheel or wheel assembly encounters the first road feature, the active suspension system may reduce the distance between the first wheel or wheel assembly and the chassis and/or vehicle body (e.g., move the wheel or wheel assembly upward) to compensate for the increased elevation of the first road feature. Accordingly, the vehicle control system of the vehicle 100 may be able to compensate for the effect of the first road features 302A on the vehicle chassis and/or vehicle body and substantially maintain the isolation control line 114A based on a chassis and/or vehicle body motion parameter (e.g., chassis and/or vehicle body velocity) as an input. The example of FIG. 2 may correspond to a comfort mode of a vehicle, where an objective of the vehicle control system is to isolate the chassis and/or vehicle body from all disturbances. In some other embodiments, idealized skyhook control based only on chassis and/or vehicle body velocity may not be employed as such an arrangement may result in end of travel events for a suspension system depending on particular road conditions and road features. In some such other embodiments, weak skyhook or weak groundhook control may be implemented based on blended inputs of both a suspension motion parameter and chassis and/or vehicle body motion parameter. In weak skyhook control, the vehicle would demonstrate the behavior shown by the isolation control line 114A, but with some deviations from disturbances (e.g., moving the chassis and/or vehicle body) from encountering road features. An example of a blended implementation is discussed further with reference to FIG. 4.

FIG. 3 is a schematic of an embodiment of a vehicle 100 under control where a suspension motion parameter is a dominant input to a vehicle control system. In the embodiment of FIG. 3 as in the embodiment of FIG. 2, a vehicle control system has implemented a control scheme that may seek to reduce motion of the portion of the vehicle contributing input. The vehicle control system may be operated based on feedback including a first input (e.g., a suspension motion parameter) and a second input (e.g., a chassis and/or vehicle body motion parameter). The two inputs may be blended in a frequency domain based on a tuning parameter (e.g., a single tuning parameter). In some embodiments, the tuning parameter may be a crossover frequency which establishes a frequency threshold where frequencies below the crossover frequency are contributed by the first input (e.g., suspension motion parameter) and frequencies above the crossover frequency are contributed by the second input (e.g., chassis and/or vehicle body motion parameter).

In the embodiment of FIG. 3, the selected tuning parameter may result in a suspension motion parameter such as suspension velocity making a larger contribution to a blended input as compared to a chassis and/or vehicle body motion parameter such as chassis and/or vehicle body velocity. For example, the tuning parameter may be a crossover frequency of approximately 3 Hz. According to this example, the frequency content of the input to the vehicle control system below 3 Hz may be based on the suspension motion parameter, and above 3 Hz may be based on the chassis and/or vehicle body motion parameter. As a result of the suspension motion parameter being favored by the tuning parameter, the vehicle control system seeks to reduce motion of the suspension, thereby maintaining a fixed distance between a chassis and/or vehicle body of the vehicle and the road surface 300 at least as much as may be physically imposed by the active suspension system (e.g., groundhook control). In this manner, the forces generated by external disturbances like road features 302A, 302B, 302C, 302D are transferred to the chassis and/or vehicle body 102 via the first wheel or wheel assembly 106A and the second wheel or wheel assembly 106B. An exemplary tracking control line 114B is shown in FIG. 3, showing the path of the center of mass 104 as the vehicle traverses the road surface 300. As shown in FIG. 3, the tracking control line 114B mirrors the profile of the road features 302A, 302B, 302C, 302D. Under the tracking control of FIG. 3, the first wheel or wheel assembly 106A may remain in a center point (or other predetermined point) of its range of motion 112A. Likewise, the second wheel or wheel assembly 106B may remain in a center point (or other predetermined point) of its range of motion 112B. The tracking control line 114B may represent idealized groundhook control where the controller is operating based on only suspension motion parameter input. It should be noted that FIG. 3 demonstrates groundhook control for the sake of explanation. In other embodiments, a vehicle may not implement groundhook control based solely on input of suspension motion parameter, as the force transmission from the road surface 300 to the chassis and/or vehicle body 102 may be undesirable. In such other embodiments, weak groundhook may be employed, which demonstrates the tracking behavior shown by tracking control line 114B, but with some compensation for disturbances (e.g., by allowing wheel or wheel assembly travel to absorb the disturbances). Weak groundhook control may be based on a blended input of both a suspension motion parameter and a chassis and/or vehicle body motion parameter. An example of a blended implementation is discussed further with reference to FIG. 4.

As discussed previously, the inventors have recognized the benefits of a vehicle control system that creates a blended input in the frequency domain based on a tuning parameter, a first input (e.g., a suspension motion parameter), and a second input (e.g., a chassis and/or vehicle body motion parameter). Such an arrangement allows a single control system or control module to achieve different performance of an active suspension system by varying, for example, a single parameter in some embodiments (e.g., the tuning parameter). By adjusting the tuning parameter according to a vehicle mode, different control outcomes can be achieved. For example, a vehicle in a comfort mode may operate similarly to the example of FIG. 2, where chassis and/or vehicle body isolation is the objective of the vehicle control system, and a blended input is primarily composed of a chassis and/or vehicle body motion parameter. As another example, a vehicle in a sport mode may operate similarly to the example of FIG. 3, where road tracking is the objective of the vehicle control system, and an input is primarily composed of a suspension motion parameter. However, the inventors have recognized that the blend of the two inputs may not be complete, such that a blended input includes some component of a suspension motion parameter and a component of a chassis and/or vehicle body motion parameter. As a result, the vehicle performance may be a blend of the examples of FIGS. 2 and 3, as shown in FIG. 4.

As shown in FIG. 4, a vehicle 100 may be controlled such that a suspension motion parameter and a chassis and/or vehicle body motion parameter both contribute to a blended input to a vehicle control system. In the embodiment of FIG. 4 as in the embodiments of FIGS. 2-3, a vehicle control system has implemented a control scheme that may seek to reduce motion of the portion of the vehicle contributing input. The vehicle control system may be operated based on feedback including a first input (e.g., a suspension motion parameter) and a second input (e.g., a chassis and/or vehicle body motion parameter). The two inputs may be blended in a frequency domain based on a tuning parameter (e.g., a single tuning parameter), which may be a crossover frequency. In the embodiment of FIG. 4, the selected tuning parameter may result in a suspension motion parameter and chassis and/or vehicle body motion parameter both contributing to different frequency domains in a blended input to achieve a blended response of groundhook and skyhook control. As shown in FIG. 4, a blended control line 114C is shown between the idealized isolation control line 114A and the idealized tracking control line 114B. The tuning parameter in the example of FIG. 4 may be approximately between the tuning parameters of the examples of FIGS. 2 and 3. The blended control line 114C demonstrates that a center of mass 104 of a chassis and/or vehicle body 102 of the vehicle 100 is isolated from disturbances caused by road features 302A, 302B, 302C, 302D, but also has a component of road tracking.

According to the examples of FIG. 4, increasing the tuning parameter (e.g., raising a crossover frequency) may yield a performance more similar to the example of FIG. 3. That is, increasing the tuning parameter may yield more road tracking performance, as a greater portion of the blended input is contributed by a suspension motion parameter. Conversely, decreasing the tuning parameter (e.g., lowering a crossover frequency) may yield a performance more similar to the example of FIG. 2. That is, decreasing the tuning parameter may yield more isolation control performance, as a greater portion of the blended input is contributed by a chassis and/or vehicle body motion parameter. Accordingly, the tuning parameter may be, for example, a single parameter that may be tuned according to different vehicle modes to achieve differing levels of performance, or to establish general operation of an active suspension system. The example shown in FIG. 4 may be representative of a variety of vehicle modes, including a sport mode, comfort mode, or economical mode, depending on the particular tuning parameter assigned to that mode. In some embodiments, a sport mode, comfort mode, and economical mode may all include control based on a blended input including contributions from both a suspension motion parameter and a chassis and/or vehicle body motion parameter.

It should be noted that exemplary vehicle control systems described herein and with reference to FIGS. 2-4 discuss filtering input information according to a tuning parameter (e.g., crossover frequency). It should be noted that while in some embodiments a filter may be complete, in other embodiments filtering may be partial. For example, in some embodiments a complementary filter may filter out all contribution of a suspension motion parameter above a crossover frequency and may filter out all contribution of a chassis and/or vehicle body motion parameter below the crossover frequency. In some other embodiments, a complementary filter may filter some contribution of a suspension motion parameter above a crossover frequency and may filter out some contribution of a chassis and/or vehicle body motion parameter below the crossover frequency. According to some such examples, the filter may apply a reductive factor to the portions of the filtered parameter without entirely eliminating its contributions to a blended input. In some embodiments a filter may reduce the contribution of a vehicle parameter by 51-100% in frequency ranges configured to be dominated by another parameter. Of course, other ranges different from the above may also be used as the disclosure is not so limited.

FIG. 5 is a block diagram of one embodiment of a vehicle control system 200. In the embodiment of FIG. 5, the vehicle control system 200 may be configured to control an active suspension system of a vehicle. In block 202, the vehicle control system is configured to receive a vehicle mode selection. For example, the vehicle mode selection may be received as user input at a user interface such as a touch screen of an infotainment system or other user input as disclosed elsewhere herein. In block 204, based on the vehicle mode selection, control tuning parameters may be assigned, or otherwise obtained, for use by the vehicle control system. In the depicted embodiment, three control tuning parameters are assigned. Specifically, a crossover frequency is assigned, a damping gain is assigned, and a filter parameter is assigned. In other embodiments, a vehicle mode selection made be associated with setting a value for a single tuning parameter and the values for the other parameters may remain constant for different vehicle modes, as the present disclosure is not so limited. As noted previously, the one or more tuning parameters may be predetermined tuning parameters associated with one or more predetermined vehicle modes in some embodiments. Regardless, using the one or more control tuning parameters assigned in block 204, the output of the vehicle control system 200 to the active suspension system may be altered. As noted previously, the limited number of control parameters may be beneficial in that the same control scheme may be employed for multiple vehicle modes by adjusting the limited number of parameters, without individual mode controllers or extensive tuning. As shown in FIG. 5, the crossover frequency is provided to block 210, where an input frequency blend is determined. The damping gain is provided at block 212, where a gain factor is applied to determine a force applied by the active suspension system. The filter parameter is provided at block 214, where one or more filters are applied to the force output form block 212 to determine an overall force command in block 216 for the active suspension system. Each of these blocks are discussed in detail below.

Block 210 of the vehicle control system 200 is configured to receive vehicle motion parameter inputs and determine a blended input including contributions from the two inputs depending on the tuning parameter received from block 204. In the example of FIG. 5, block 210 may be a complementary filter which is employed to combine the inputs in a frequency domain based on the crossover frequency. As shown in FIG. 5, a first input 206 may be a suspension velocity. The suspension velocity may be determined or otherwise obtained by the vehicle control system based on sensor information. For example, the suspension velocity may be determined based on a derivative of a suspension position provided by a position sensor. A second input 208 may be inertial velocity (e.g., a chassis, vehicle body, or sprung mass velocity). The chassis and/or vehicle body velocity may be determined or otherwise obtained by the vehicle control system based on sensor information. For example, the inertial velocity may be determined based on an integral of acceleration information provided by an accelerometer disposed on the chassis and/or vehicle body. The complementary filter may be configured to add the suspension velocity and the inertial velocity input signals together to produce an overall blended velocity input that is used in the determination of a force command. The content of the suspension velocity and the inertial velocity are added together after filtering the signals in certain frequency ranges that are driven by the crossover frequency. As shown in FIG. 5, a 2^{nd} order low pass filter may be applied to the suspension velocity first input 206. The low pass filter may be based on the crossover frequency, such that the content of the suspension velocity signal with frequencies greater than the crossover frequency may be reduced or eliminated entirely. An inverse 2^{nd} order low pass filter may be applied to the inertial velocity as the second input (e.g., a high pass filter is applied to the inertial velocity). The filter applied to the inertial velocity may also be based on the crossover frequency, such that the content of the inertial velocity signal with frequencies less than the crossover frequency is reduced or eliminated. The filtered first input 206 and filtered second input 208 may then be combined to generate a blended input. The blended input signal will be composed of content of both the first input and second input, with the first input dominating frequencies below the crossover frequency, and the second input dominating frequencies above the crossover frequency. As the crossover frequency changes based on a vehicle mode selection in block 202, the response of the vehicle control system 200 may be changed by changing the frequency content of the blended input. The inventors have recognized the specific benefits of a control scheme where suspension velocity is employed as an input at lower frequencies (e.g., less than about 3 Hz), because higher frequencies may degrade comfort for passengers within the vehicle. The inventors have further recognized the specific benefits of a control scheme where chassis and/or vehicle body velocity is employed as an input at higher frequencies (e.g., between 0.3 and 10 Hz) as the chassis and/or vehicle body velocity may be a clean signal at higher frequencies but performs less well at lower frequencies (e.g., less than 0.3 Hz). This is because at the lower frequencies, in some instances the chassis and/or vehicle body velocity can create large commands that use an undesirable amount of wheel or wheel assembly travel. Accordingly, the inventors have recognized the benefits of a high-pass filter applied to the chassis and/or vehicle body velocity signal to avoid such commands that may use too much wheel or wheel assembly travel.

In some embodiments, in block 210 of the example of FIG. 5, the low pass filters may be complete, such that all frequency content above or below the crossover frequencies is eliminated from the blended input signal. In other embodiments filtering may be partial such that a portion of the signal for both inputs be included in the blended input but is not dominant outside of its assigned frequency range. For example, in some other embodiments, a complementary filter may filter some contribution of a suspension velocity above a crossover frequency and may filter out some contribution of a chassis and/or vehicle body velocity below the crossover frequency. In some embodiments a filter may reduce the contribution of a vehicle motion parameter by 51-100% in frequency ranges dominated by another motion parameter, though other ranges may also be used. Such an arrangement may ensure that a majority of the blended input signal in an assigned frequency range is contributed by the respectively assigned vehicle motion parameter input.

In block 212, a damping gain is employed to covert the blended input from block 210 into a force. That is, the damping gain from block 204 may be used to determine a force based at least in part on the blended velocity signal. The force may be based on the contributions of the suspension velocity first input 206 and the inertial velocity second input 208.

In block 214, the force from block 212 may be shaped by one or more filters. The filter parameters may determine which filters are applied to the force output from block 212. Accordingly, the application of filters in block 214 may be based on the vehicle mode selection in block 202. For example, selection of a sport mode may include application of a general low pass filter (e.g., at approximately 3 Hz) to shape the force output to focus on the target frequencies ranges for force application that improve sport performance. As another example, a comfort mode may include application of a phase lead filter (e.g., at approximately 7 Hz) to increase isolation at secondary ride frequencies (e.g., at frequencies approximately equal to or greater than 7 Hz). The filters of block 214 may be optional, in some embodiments.

In block 216, the vehicle control system provides an overall force command. In some embodiments, the overall force command may be at the vehicle level and may be distributed to individual actuators of an active suspension system. However, embodiments in which the desired force commands are determined for individual corners of the vehicle are also contemplated as the disclosure is not limited to which forces are being determined with the disclosed control methods. The overall force command may be based on the outputs of blocks 210, 212, and 214, each of which may be modified based on the vehicle mode selection in block 202. The general control scheme of FIG. 5 may be employed for a variety of vehicles and may enable rapid tuning of different vehicle modes by blending vehicle motion parameter inputs (e.g., velocity parameters) in the frequency domain.

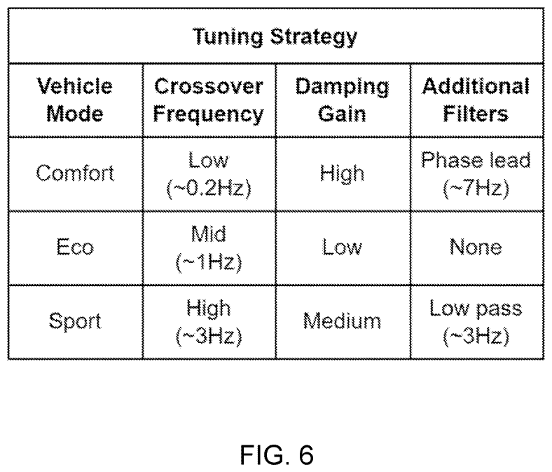

FIG. 6 depicts one embodiment of a tuning strategy for a vehicle control system including different modes. Specifically, FIG. 6 depicts exemplary values for tuning parameters for a vehicle control system like that of FIG. 5. The inventors have recognized that the values and relative relationships shown in FIG. 6 may have benefits in vehicle performance. However, the specific values listed are exemplary, and are not limiting in this regard. As shown in FIG. 6, in a comfort mode a crossover frequency may be approximately 0.2 Hz. A damping gain may be high (as compared to other vehicle modes), and a phase lead filter may be applied at approximately 7 Hz. The comfort mode may be most similar to the response of FIG. 2, where chassis and/or vehicle body isolation is prioritized. In an eco mode, a crossover frequency may be approximately 1 Hz, greater than the crossover frequency of the comfort mode. Damping gain may be low, such that the force output from the vehicle control system is diminished to save power. No additional filters may be employed. In a sport mode, a crossover frequency may be approximately 3 Hz, greater than the comfort mode or the economical mode. Damping gain may be medium, between that of the comfort mode and the eco mode. A low pass filter may be applied at approximately 3 Hz.

It should be noted that while specific inputs are described with reference to the example of FIGS. 5-6, other inputs are contemplated, as the present disclosure is not so limited. Techniques described herein may be applicable to blending a variety of vehicle motion parameters to provide a tuning parameter that allows for straightforward adjustment of a vehicle controller output for different vehicle modes. Additionally, while specific values for parameters are described with reference to FIG. 6, other values are contemplated, as the present disclosure is not so limited. In some embodiments, a crossover frequency in a comfort mode may be between about 0.1 Hz and about 0.5 Hz. In some embodiments, a crossover frequency in a sport mode may be between about 1 Hz and about 3 Hz. In some embodiments, a crossover frequency in an eco mode may be between about 0.5 Hz and about 2 Hz. In some embodiments, a crossover frequency may be between 0.1 and 3 Hz for a variety of vehicle modes. Of course, while specific ranges for the different modes are noted above, ranges both greater than and less than those noted above for the different vehicle modes may be used as the disclosure is not so limited.

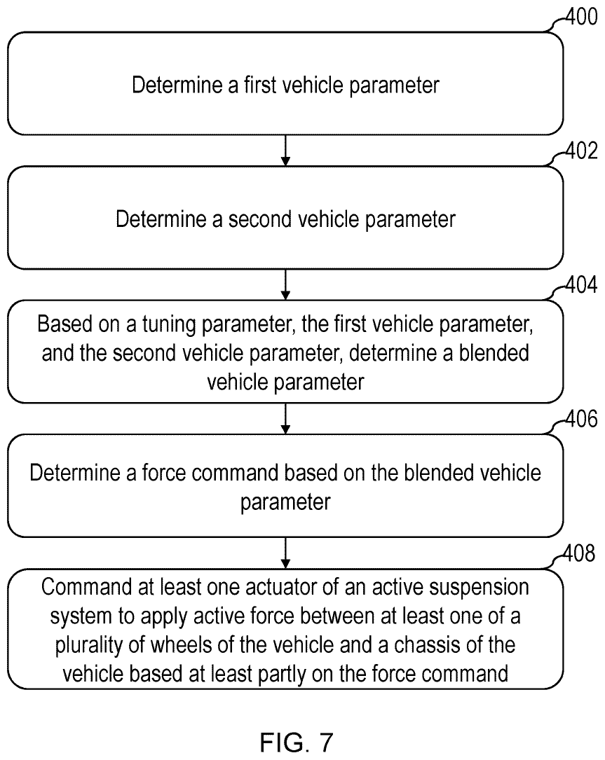

FIG. 7 is a flow chart of one embodiment of a method of controlling a vehicle. In block 400, a first vehicle parameter is determined. In some embodiments, determining a vehicle parameter may include receiving information from one or more sensors. In some embodiments, the information from the one or more sensors may be processed to determine the first vehicle parameter. For example, a derivative or integral of the sensor information may be taken. In some embodiments, the sensor information may be converted from a time domain to a frequency domain, for example using a Fourier transform. In block 402, a second vehicle parameter is determined. Similar to the first vehicle parameter, the second vehicle parameter may be determined based on received sensor information, which may be further processed. The first vehicle parameter and the second vehicle parameter may be different from one another. In some embodiments, the first vehicle parameter and the second vehicle parameter are vehicle motion parameters, which represent a signal of some motion of a portion of a vehicle. The first vehicle parameter may be associated with a suspension of the vehicle, while the second vehicle parameter may be associated with a chassis or body of the vehicle. For example, the first vehicle parameter may a suspension velocity (e.g., a velocity of the unsprung mass of the vehicle), and the second vehicle parameter may be a chassis and/or vehicle body velocity (e.g., a velocity of the sprung mass of the vehicle). The first and second vehicle parameters may be inputs to a vehicle controller for feedback control of an active suspension system.

In block 404, based on a tuning parameter, the first vehicle parameter, and the second vehicle parameter, a blended vehicle parameter may be determined. In some embodiments, the tuning parameter may be predetermined for a particular vehicle. In some embodiments, the tuning parameter may be based on a vehicle mode. In some embodiments, a vehicle mode selection may be received as user input, which may in turn establish the tuning parameter. In some embodiments, the tuning parameter may be a frequency. In some such embodiments, the determination of the blended vehicle parameter may include applying a filter, such as a complementary filter or other appropriate filter, to the first vehicle parameter and the second vehicle parameter. As discussed according to other examples herein, a complementary filter may include adding the first vehicle parameter and second vehicle parameter together in the frequency domain after filtering certain frequency ranges from each of the first vehicle parameter and the second vehicle parameter. For example, for a first frequency range below the frequency of the tuning parameter, the content of the second vehicle parameter (e.g., a chassis and/or vehicle body motion parameter) may be filtered so that it is reduced or eliminated from the blended vehicle parameter. Correspondingly, for a second frequency range above the frequency of the tuning parameter, the content of the first vehicle parameter (e.g., a suspension motion parameter) may be filtered so that it is reduced or eliminated from the blended vehicle parameter. In this manner, the blended vehicle parameter may be composed in the first frequency range below the tuning parameter frequency primarily of the first vehicle parameter and may be composed in the second frequency range above the tuning parameter frequency primarily of the second vehicle parameter. In some embodiments, the blended vehicle parameter may be a blended velocity.

In block 406, a force command may be determined based at least in part on the blended vehicle parameter. In some embodiments, determining the force command may include applying a gain factor to the blended vehicle parameter. The force command may represent a force request at the vehicle level to achieve a certain motion of the vehicle (e.g., isolation or reduction of motion). As the force command is based on the blended input, which in turn is determined based on a tuning parameter, varying the tuning parameter may change the force command determined in block 406 for the same first vehicle parameter and the second vehicle parameter. Where the first vehicle parameter and the second vehicle parameter are a suspension motion parameter and a chassis and/or vehicle body motion parameter, respectively, altering the tuning parameter may shift the overall content of the blended vehicle parameter to being more suspension or chassis and/or vehicle body oriented. Accordingly, the force command may seek to isolation motion of the suspension (e.g., groundhook) or seek to isolate motion of the chassis and/or vehicle body (e.g., skyhook) depending on the value of the tuning parameter. In this manner, the response of the vehicle may be changed by adjusting, for example, a single parameter. In some embodiments, the method may include optionally adjusting the tuning parameter, for example by receiving an updated vehicle mode selection of a user. As a result, the blended vehicle parameter may be redetermined based on the new tuning parameter, and the force command may correspondingly be updated. In block 408, at least one actuator of an active suspension is commanded to apply active force between at least one of a plurality of wheels or wheel assemblies of the vehicle and a chassis or body of the vehicle based at least partly on the force command. In some embodiments, the force command may be allocated on a per wheel or wheel assembly basis to each actuator of the active suspension system.

Optionally, the method of FIG. 7 may be cyclically repeated on any appropriate time scale to permit appropriate active control of an active suspension system or other appropriate system of a during operation vehicle. In some embodiments, the method of FIG. 7 may be performed by a vehicle control system, and in particular at least one processor of a vehicle control system. The method of FIG. 7 may be stored as computer readable instructions in a non-transitory computer-readable medium for execution by at least one processor. In some embodiments, the steps of FIG. 7 may be reordered. In some embodiments, some of the steps of FIG. 7 may be performed concurrently in parallel. For example, the first vehicle parameter may be determined at the same time as the second vehicle parameter as part of a parallel process.

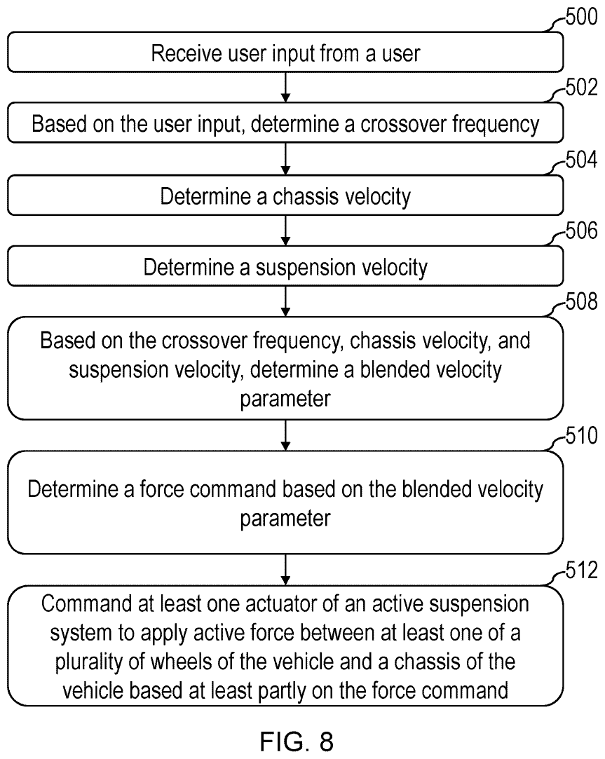

FIG. 8 is a flow chart of another embodiment of a method of controlling a vehicle. In block 500, user input is received from a user. For example, input may be received from a user at a user interface in a vehicle. In block 502, a crossover frequency may be determined based on the user input. For example, a particular crossover frequency value may be assigned to a selected vehicle mode. As another example, a user may directly input a crossover frequency value within a range (e.g., between 0.3 and 3 Hz). In block 504, a chassis and/or vehicle body velocity may be determined. In some embodiments, the chassis and/or vehicle body velocity may be determined based on integrating a chassis and/or vehicle body acceleration received from an accelerometer. In block 506, a suspension velocity may be determined. In some embodiments, the suspension velocity may be determined based on taking a derivative of a suspension position (e.g., in direction of suspension travel such as a vertical direction). In block 508, based on the crossover frequency, the chassis and/or vehicle body velocity, and the suspension velocity, a blended velocity parameter may be determined. As discussed with reference to other embodiments herein, the blended velocity parameter may be a frequency blend of the chassis and/or vehicle body velocity and the suspension velocity. The content of the blended velocity below the crossover frequency may be contributed primarily by the suspension velocity. The content of the blended velocity above the crossover frequency may be contributed primarily by the chassis and/or vehicle body velocity. In block 510, a force command may be determined based on the blended velocity parameter. In block 512, at least one actuator of an active suspension may be commanded to apply active force between at least one of a plurality of wheels or wheel assemblies of the vehicle and a chassis or body of the vehicle based at least partly on the force command. In some embodiments, the force command may be allocated on a per wheel or wheel assembly basis to each actuator of the active suspension system.

Optionally, the method of FIG. 8 may be cyclically repeated on any appropriate time scale to permit appropriate active control of an active suspension system or other appropriate system of a during operation vehicle. In some embodiments, the method of FIG. 8 may be performed by a vehicle control system, and in particular at least one processor of a vehicle control system. The method of FIG. 8 may be stored as computer readable instructions in a non-transitory computer-readable medium for execution by at least one processor. In some embodiments, the steps of FIG. 8 may be reordered. In some embodiments, some of the steps of FIG. 8 may be performed concurrently in parallel. For example, the chassis and/or vehicle body velocity may be determined at the same time as the suspension velocity as part of a parallel process.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A vehicle comprising:
a chassis and/or vehicle body;
a plurality of wheels or wheel assemblies;
an active suspension system operatively coupled to the plurality of wheels or wheel assemblies and the chassis and/or vehicle body, wherein the active suspension system comprises at least one actuator configured to apply active forces to at least one of the plurality of wheels or wheel assemblies in at least one mode of operation; and
at least one processor configured to control the active suspension system, wherein the at least one processor is configured to:
obtain a tuning parameter,
determine a first vehicle parameter,
determine a second vehicle parameter,
determine a blended vehicle parameter based at least partly on the tuning parameter, the first vehicle parameter, and the second vehicle parameter, and
command the at least one actuator to apply force between at least one of the plurality of wheels or wheel assemblies and the chassis and/or vehicle body based at least partly on the blended vehicle parameter.

2. The vehicle of claim 1, wherein the first vehicle parameter is a chassis and/or vehicle body velocity, and wherein the second vehicle parameter is a suspension velocity.

3. The vehicle of claim 1, further comprising at least one first sensor and at least one second sensor, wherein the at least one processor is further configured to:
receive first sensor information from the at least one first sensor;
determine the first vehicle parameter based on the first sensor information;
receive second sensor information from the at least one second sensor; and
determine the second vehicle parameter based on the second sensor information.

4. The vehicle of claim 3, wherein the at least one first sensor comprises a first accelerometer disposed on the chassis and/or vehicle body, and wherein the at least one second sensor comprises an accelerometer disposed on the active suspension system.

5. The vehicle of claim 1, wherein the tuning parameter is a crossover frequency, and wherein determining the blended vehicle parameter comprises applying a complementary filter to the first vehicle parameter and the second vehicle parameter based on the crossover frequency.

6. The vehicle of claim 5, wherein the crossover frequency is between 0.2 and 3 Hz.

7. The vehicle of claim 5, wherein applying the complementary filter comprises:
filtering frequencies of the first vehicle parameter above the crossover frequency;
filtering frequencies of the second vehicle parameter below the crossover frequency; and
adding the filtered first vehicle parameter and the filtered second vehicle parameter together.

8. The vehicle of claim 1, wherein the at least one processor is further configured to obtain a damping gain, wherein the command to the at least one actuator is based at least partly on the damping gain.

9. The vehicle of claim 8, wherein obtaining the damping gain comprises receiving user input of a vehicle mode.

10. The vehicle of claim 1, wherein the at least one processor is further configured to apply a low pass filter to the blended vehicle parameter, wherein the command to the at least one actuator is based at least partly on the filtered blended vehicle parameter.

11. The vehicle of claim 1, wherein the at least one processor is further configured to apply a phase lead filter to the blended vehicle parameter, wherein the command to the at least one actuator is based at least partly on the filtered blended vehicle parameter.

12. The vehicle of claim 1, wherein the command is configured to control a heave and/or pitch of the vehicle.

13. The vehicle of claim 1, wherein obtaining the tuning parameter comprises receiving user input of a vehicle mode, wherein the tuning parameter is based on the vehicle mode.

14. The vehicle of claim 1, wherein the tuning parameter is a first tuning parameter, wherein the blended vehicle parameter is a first blended vehicle parameter, and wherein the at least one processor is further configured to:
change the first tuning parameter to a second tuning parameter;
determine a second blended vehicle parameter based at least partly on the second tuning parameter, the first vehicle parameter, and the second vehicle parameter; and
command the at least one actuator to apply force between at least one of the plurality of wheels or wheel assemblies and the chassis and/or vehicle body based at least partly on the second blended vehicle parameter, wherein the command based at least at least partly on the second blended vehicle parameter changes a response to the vehicle to road events relative to the command based at least partly on the first blended vehicle parameter.

15. A method of controlling a vehicle including a chassis and/or vehicle body, a plurality of wheels or wheel assemblies, and an active suspension system, wherein the active suspension system is operatively coupled to the plurality of wheels or wheel assemblies, and wherein the active suspension system comprises at least one actuator configured to apply active forces to at least one of the plurality of wheels or wheel assemblies in at least one mode of operation, the method comprising:
obtaining a tuning parameter;
determining a first vehicle parameter;
determining a second vehicle parameter;
determining a blended vehicle parameter based at least partly on the tuning parameter, the first vehicle parameter, and the second vehicle parameter; and
commanding the at least one actuator to apply force between at least one of the plurality of wheels or wheel assemblies and the chassis and/or vehicle body based at least partly on the blended vehicle parameter.

16. The method of claim 15, wherein the first vehicle parameter is a chassis and/or vehicle body velocity, and wherein the second vehicle parameter is a suspension velocity.

17. The method of claim 15, comprising:
receiving first sensor information from at least one first sensor;
determining the first vehicle parameter based on the first sensor information;
receiving second sensor information from at least one second sensor; and
determining the second vehicle parameter based on the second sensor information.

18. The method of claim 17, wherein the at least one first sensor comprises a first accelerometer disposed on the chassis and/or vehicle body, and wherein the at least one second sensor comprises an accelerometer disposed on the active suspension system.

19. The method of claim 15, wherein the tuning parameter is a crossover frequency, and wherein determining the blended vehicle parameter comprises applying a complementary filter to the first vehicle parameter and the second vehicle parameter based on the crossover frequency.

20. The method of claim 19, wherein the crossover frequency is between 0.2 and 3 Hz.

21. The method claim 19, wherein applying the complementary filter comprises:
filtering frequencies of the first vehicle parameter above the crossover frequency;
filtering frequencies of the second vehicle parameter below the crossover frequency; and
adding the filtered first vehicle parameter and the filtered second vehicle parameter together.

22. The method of claim 15, further comprising obtaining a damping gain, wherein commanding the at least one actuator is based at least partly on the damping gain.

23. The method of claim 22, wherein obtaining the damping gain comprises receiving user input of a vehicle mode.

24. The method of claim 15, further comprising applying a low pass filter to the blended vehicle parameter, wherein commanding the at least one actuator is based at least partly on the filtered blended vehicle parameter.

25. The method of claim 15, further comprising applying a phase lead filter to the blended vehicle parameter, wherein commanding the at least one actuator is based at least partly on the filtered blended vehicle parameter.

26. The method of claim 15, wherein the command is configured to control a heave and/or pitch of the vehicle.

27. The method of claim 15, wherein obtaining the tuning parameter comprises receiving user input of a vehicle mode, wherein the tuning parameter is based on the vehicle mode.

28. The method of claim 15, wherein the tuning parameter is a first tuning parameter, wherein the blended vehicle parameter is a first blended vehicle parameter, and wherein the method further comprises:
changing the first tuning parameter to a second tuning parameter;
determining a second blended vehicle parameter based at least partly on the second tuning parameter, the first vehicle parameter, and the second vehicle parameter; and
commanding the at least one actuator to apply force between at least one of the plurality of wheels or wheel assemblies and the chassis and/or vehicle body based at least partly on the second blended vehicle parameter, wherein the command based at least at least partly on the second blended vehicle parameter changes a response to the vehicle to road events relative to the command based at least partly on the first blended vehicle parameter.

29. A non-transitory computer readable medium including processor executable instructions that when executed by at least one processor perform the method of any claim 15.
